(19) United States
(12) Patent Application Publication
(10) Pub. No.: US 2010/0281694 A1
(43) Pub. Date: Nov. 11, 2010

(54) Razors

(76) Inventor: Terence Gordon Royle, Hampshire (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/989,820

(22) PCT Filed: Aug. 3, 2006
(86) PCT No.: PCT/IB2006/052679

§ 371 Date: Jul. 29, 2010

(30) Foreign Application Priority Data
Aug. 3, 2005 (GB) 0515990.0

(51) Int. Cl. B26B 19/12; B26B 21/14; B26B 21/00; B26B 19/28; B26B 21/52

(52) U.S. Cl. 30/43.7; 30/77; 30/84; 30/50; 30/42; 30/527

(57) ABSTRACT

A blade unit (110) for a razor including a guard element (35) , first and second cap elements (36,37) on opposite sides of the guard element, a plurality of blades (32) with cutting edges (33) disposed between the guard element and the first cap element and facing towards the guard element. At least one blade with a cutting edge is disposed between the guard element and the second cap element and faces towards the guard element. The first cap element, guard element and second cap element are circumscribed by an arc of a circle (46) . A first plane (47) extends between positions at which the circumscribing arc meets a first surface (35a) on the guard element and a surface on the first cap element. A second plane (48) extends between positions at which the circumscribing arc meets a second surface (35b) on the guard element and a surface (37b) on the second cap element. The cutting edge of at least one of the blades in the plurality of blades has a position that is above the first plane and at or below the circumscribing arc.

### FIELD OF THE INVENTION

This invention relates to razors and in particular to razors of the kind in which blades with sharp cutting edges are positioned between guard and cap surfaces that contact the skin as the cutting edges are moved over the skin for severing hairs that project from the skin.

### BACKGROUND OF THE INVENTION

Safety razors generally comprise a handle by means of which one or more blades with sharp cutting edges are moved across the surface of the skin in performing a shaving stroke with the razor. Usually there is a guard for contact with the skin in front of the cutting edges of the blades and a cap for contacting the skin behind the cutting edges, the guard and cap elements being important for establishing the so-called shaving geometry that is critical in determining the shaving performance. Factors by which shaving performance can be judged include closeness, comfort and safety. The parameters of the shaving geometry that influence the shaving performance include the blade span, which is the distance from the cutting edge of a blade to the surface of the skin contacting element next in front of that cutting edge, blade exposure, which is in the height of the cutting edge of a blade above a plane tangential to the skin contacting elements immediately in front of and behind that cutting edge, and the blade angle, which is the angle at which a plane bisecting the tip of the blade intersects a plane extending between skin contacting surfaces of the cap and guard. There have been many prior proposals for appropriate shaving geometries for razors designed for unidirectional use, that is to be moved in one predetermined direction across the skin during shaving. In W095/09071 (Gilder et al) and W096/29183 (Gilder et al) there is disclosed an effective shaving geometry for a razor with three blades between the guard and the cap of the razor.

Although unidirectional safety razors are most common, there are also known razors with blades that are arranged with their cutting edges facing in opposite directions so that the razor is bi-directional and can be used with a back and forth movement in the course of shaving so that respective blades are effective in cutting hairs during forward strokes and rearward strokes of the razor. In U.S. Pat. No. 6,161,288 (Andrews) for example there are described several razor constructions in which two pairs of blades are arranged on opposite sides of a central cap member with the cutting edges of the blade pairs facing away from each other and towards respective guard members. Described in WO 2004/037037 (Coffin et al) is a razor having two pairs of blades included in respective blade assemblies on opposite sides of a central guard, the cutting edges of the blades facing inwardly towards the guard. The cutting edges have rest positions slightly above a plane extending between cap surfaces located behind the respective blade pairs, and the blade assemblies are movable for the cutting edges to retract into the housing under influence of forces encountered during shaving. The guard is shown to project significantly above the shaving plane so that the cutting edges are below planes extending between the guard and cap surfaces.

The present invention has for its aim to provide improved shaving geometry for a blade unit of a razor adapted for bi-directional shaving.

### SUMMARY OF THE INVENTION

Provided in accordance with the invention is a blade unit in or for a razor comprising a guard element, first and second cap elements on opposite sides of the guard element, a plurality of blades with cutting edges disposed between the guard element and the first cap element and facing towards the guard element, and at least one blade with a cutting edge disposed between the guard element and the second cap element and facing towards the guard element, wherein the first cap element, the guard element and the second cap element are circumscribed by an arc of a circle, a first plane extends between positions at which the circumscribing arc meets a first surface on the guard element and a surface on the first cap element, a second plane extends between positions at which the circumscribing arc meets a second surface on the guard element and a surface the second cap element, characterised in that the cutting edge of at least one of the blades in said plurality of blades has a position that is above the first plane and at or below the circumscribing arc.

A blade unit construction in accordance with the invention is especially suited for use in a razor which is equipped with a motor for driving the blade unit so that bi-directional shaving is achieved even when the razor as a whole is moved unidirectionally across the skin surface. Such a razor is described in our pending UK patent application No. 0432099.1 (Royle & Saker) filed on 18 Oct. 2004, the contents of which are incorporated herein by reference. In a preferred embodiment the blade unit is mounted for pivotal movement relative to a handle of the razor about an axis located substantially at the centre of curvature of the circumscribing arc. A drive mechanism actuable by the motor may be operable to oscillate the blade unit about the pivot axis through an angle that results in a stroke of blade movement in the range of about 0.3 mm to about 3.0 mm, e.g. an angle of 5° to 30° with the blade edges at a radius of about 10 mm from the pivot axis.

The first and second surfaces on the guard element may be respective areas of the same surface or the same part of a surface on the guard element. In many embodiments the surfaces on the guard and cap element met by the circumscribing arc are surfaces on these elements which contact the skin during shaving.

There may be one or more additional blades on either side of the guard element and the cutting edge of any such additional blade may face either towards or away from the guard element. In a preferred construction there is a second plurality of blades with cutting edges disposed between the guard element and the second cap element, and the cutting edge of at least one of the blades in the second plurality of blades has a position that is not below, preferably above, the second plane and at or below the circumscribing arc. There may be two, three, four or more blades in the or each plurality of blades, a preferable arrangement being for equal numbers of blades, e.g. two blades on each side of the guard element and the blades being disposed in symmetrical arrangements on opposite sides of the guard element.

The cutting edge of each blade in the or each plurality of blades is ideally positioned between the circumscribing arc and the adjacent one of the first and second planes.

In a preferred construction, in at least one plurality of blades the cutting edge of a blade further from the guard element is positioned at a greater distance from the adjacent one of the first and second planes than the cutting edge of a blade closer to the guard element. Furthermore, the cutting edge of a blade further from the guard element has a position inside the circumscribing arc and at a greater distance from the circumscribing arc than the cutting edge of a blade closer to the guard element.

Suitably the circumscribing arc has a radius of from 8.0 mm to 12.0 mm, such as 9.0 mm to 11.0 mm and preferably from 9.5 mm to 10.5 mm In at least one plurality of blades the cutting edge of the blade closest to the guard element is at a distance of from 0.2 to 1.2 mm, preferably 0.2 to 0.7 mm and more precisely 0.25 to 0.45 mm, from a point at which extension of the first and second planes intersect, this distance being measured along the adjacent plane. Also, in at least one plurality of blades the tips of the cutting edges of two adjacent blades are separated by a distance of 0.2 to 1.5 mm, preferably 0.6 to 1.2 mm, and more specifically 0.9 to 1.1 mm, this distance being measured along the adjacent plane.

In the preferred structural arrangement the or each plurality of blades includes a front blade nearest the guard element and a following blade, the tip of the cutting edge of the front blade has a position at a distance of from 0.02 to 0.03 mm above the adjacent one of the first and second planes, and/or the tip of the cutting edge of the following blade has a position at a distance of from 0.03 to 0.07 mm, preferably 0.04 to 0.06 mm above the plane.

The blade edge positions defined by the dimensions detailed above are those preferred and at which the blades may be fixed relative to the guard and/or cap elements, but it may be desirable for the blades to be movable into or away from these positions during shaving, for example as a result of the shaving forces that are imparted on components of the blade unit.

### DESCRIPTION OF THE DRAWINGS

The foregoing and other features of the invention will be better understood from the detailed description that follows and in which reference is made to the accompanying drawings, wherein

FIG. 1 is an isometric view illustrating a blade unit embodying the invention;

FIG. 2 is a sectional isometric view showing half of the blade unit;

FIG. 3 is a transverse cross-section through the blade unit;

FIG. 4 is a simplified cross-section on an enlarged scale to show the blade positions;

FIG. 5 is a further enlarged sectional view illustrating the blade positions of one pair of blades;

FIG. 6 is an isometric view showing a safety razor incorporating the blade unit of FIGS. 1-5;

FIG. 7 is an exploded view of the head structure of the safety razor shown in FIG. 6; and

FIG. 8 is an enlarged cross-section through the head structure of the razor shown in FIG. 6.

### DETAILED DESCRIPTION OF THE PREFERRED EMBODIMENT

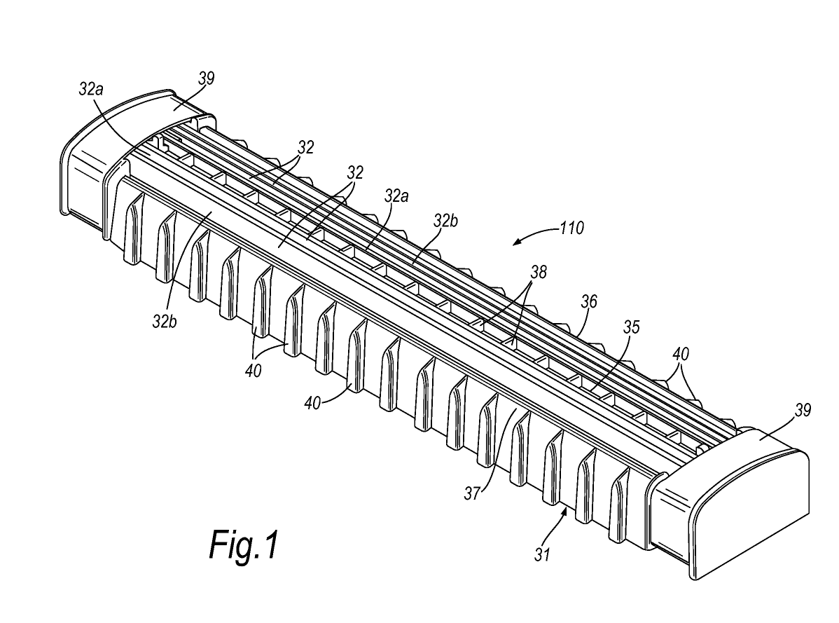

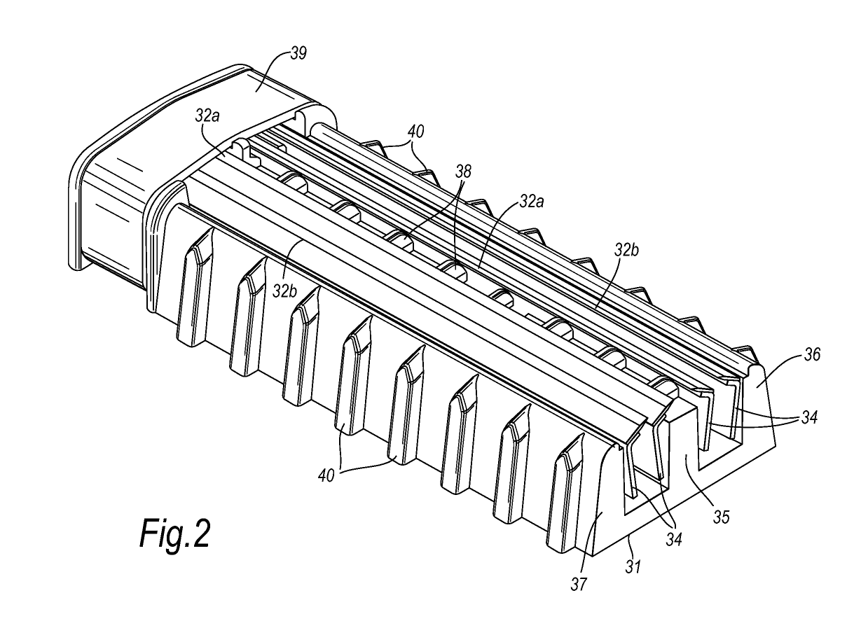

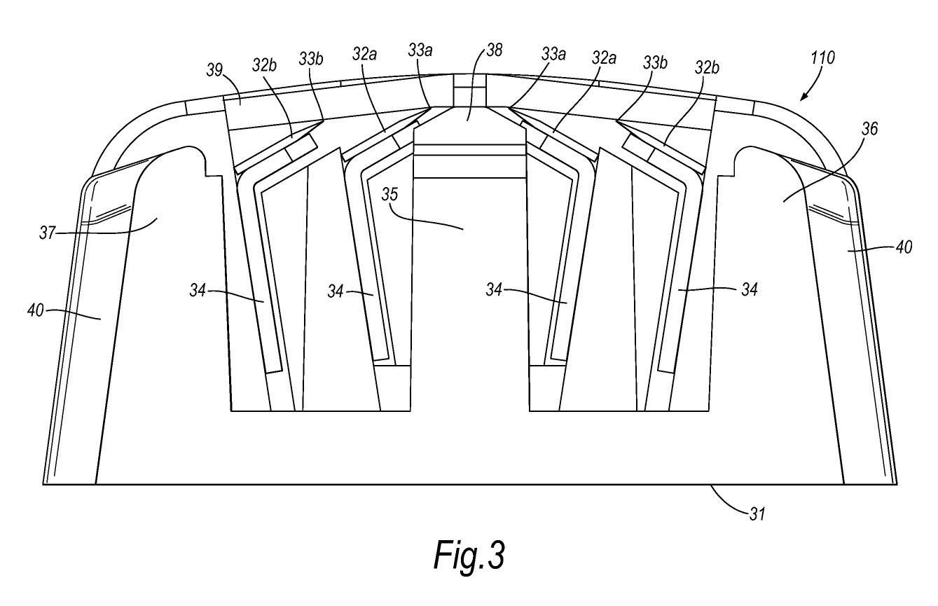

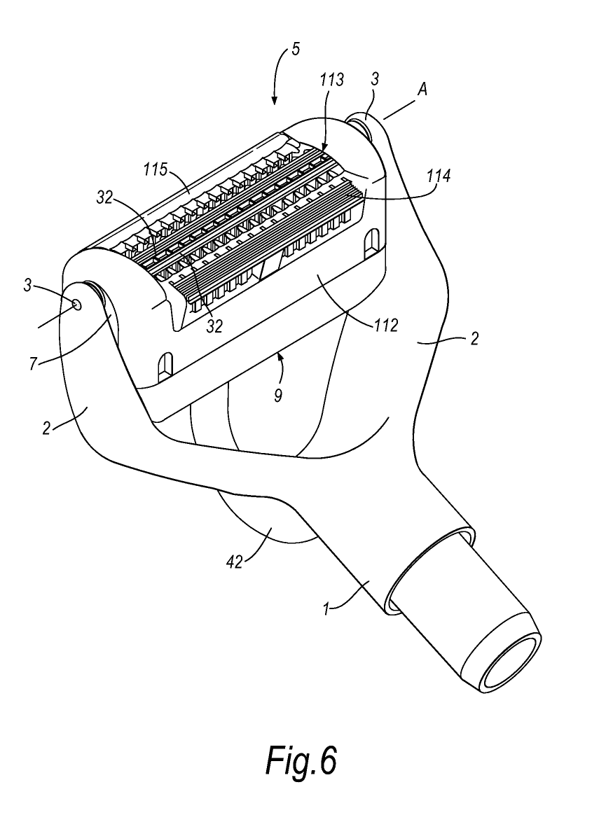

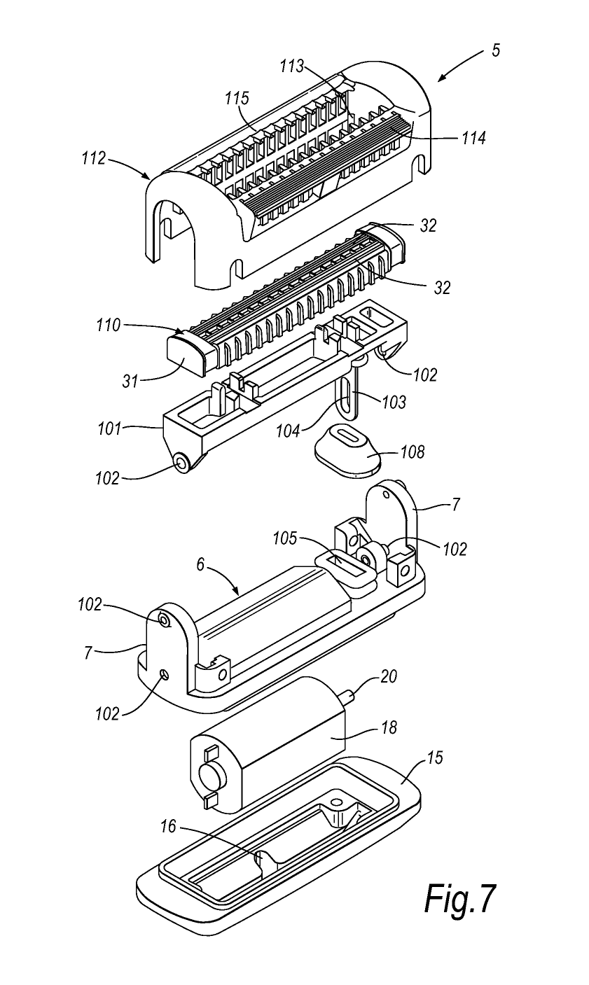

The safety razor blade unit 110 illustrated in FIGS. 1 to 5 and described in detail below is adapted for use in the safety razor shown in FIGS. 6-8.

The safety razor has a handle 1, only an upper part of which is shown. The handle has a bifurcated upper end defining a pair of yoke arms 2 having pivot elements 3 at their free ends. Pivotally connected to the pivot elements 3 for pivotal motion relative to the handle about a pivot axis A transverse to the length of the handle 1 is a razor head structure 5. The head structure includes a body 6 with a pair of end members 7 respectively connected to the pivot elements 3 and integrally attached to opposite end walls of a motor housing 9. The housing has a bottom cover 15 formed with an externally projecting tubular spigot 14 defining a cable entry opening 16. An electric motor 18 is sealed within the chamber enclosed by the housing 9 and has an output drive shaft 19 with an eccentric cam element 20. A flexible tube 42 interconnects a spigot on the handle with the spigot 14 on the motor housing for electrical cable conductors to pass between the handle 1 and the head structure 5 for conducting electric current from a battery accommodated in the handle to the electric motor 18.

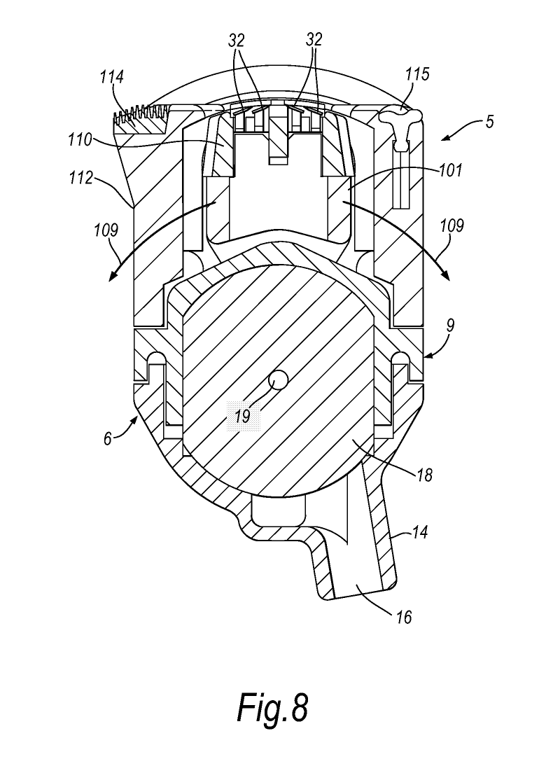

A blade unit platform 101 is pivotally mounted between the end members 7 by journals 102, and a drive arm 103 with an elongated slot 104 extends downwardly from the platform 101. The arm 104 passes freely through a slot 105 formed in the top wall of the motor housing to which the arm 104 is sealed by a flexible sealing boot 108. The output drive shaft 19 of the motor carries an eccentric cam element 20 which engages in the slot 104 so that, when the motor is energised, the blade unit platform 101 is caused to rock back and forth about its pivot as indicated by the arrows 109 in FIG. 8. The platform 101 carries the blade unit 110 which includes two sets of oppositely facing blades 32 supported on a frame 31 that is connected to the platform 101 so that the blade unit 110 rocks with the platform relative to the body 6 of the head structure 5. A cartridge casing 112 is fitted to the body 6 to enclose the blade unit 110 and the platform 101, the casing having an opening 113 through which the cutting edges of the blades 32 are exposed. As shown the cartridge casing 112 is provided with an elastomeric guard strip 114 at the front side of the opening 113 and a lubricating strip 115 defining a cap surface at the rear side of the opening 113. The head structure 5 as a whole is pivotable about the axis A relative to the handle 1. When the motor 18 is energised the platform 101 and blade unit 110 carried thereon are caused to oscillate so that the blades 32, and more importantly their cutting edges perform an arcuate reciprocation within the opening 113 of the cartridge casing 112 whereby the sets of blades 32 act alternately to cut hairs protruding from a skin surface against which the razor is applied in performing a shaving stroke. The arcuate reciprocation of the blade unit is achieved with a simple drive transmission between the motor 18 and the support platform 101 that is economic to manufacture and assemble, despite the fact that the shaving cartridge as a whole is free to pivot on the handle for following the skin contours in the course of executing a shaving stroke. The razor as so far described is also described in pending UK patent application No. 0423151.0 (Royle) filed on 18 Oct. 2004.

The blade unit 110 which is shown in detail in FIGS. 1-5 comprises a moulded plastic frame 31 having an E-shaped cross-section defining three upstanding elements extending upwardly from a base 34, namely a central element 35 that acts as a guard and two outer elements 36, 37 that act as respective caps. A first pair of blades 32a, 32b is positioned with the cutting edges 33a, 33b of the blades disposed between the guard element 35 and the first cap element 36, and a second pair of blades 32a, 32b is positioned with the cutting edges 33a, 33b of these blades disposed between the guard element 35 and the second cap element 37. It will be understood that the two pairs of blades 32a, 32b act alternately to cut hairs as the blade unit 110 is oscillated by the motor 18 on the support platform 101, and the razor head is moved across the skin surface. The contact between the cutting edges 33a, 33b of each pair of blades and the skin surface is controlled by the guard element 35 and respective cap element 36 as the blades and the skin surface is controlled by the guard element 35 and respective cap element 36 as the blade pairs perform forward cutting strokes.

The guard element 35 has a castellated top with upwardly directed projections 38 uniformly spaced apart along the guard element 35. Other forms of guard element for example a guard element with a continuous top surface, are also possible. The blades 32 are mounted on blade supports 34 in predetermined positions with respect to the top of the guard element 35, as defined by the free upper end faces of the projections 38, and the top surfaces of the cap elements 36, 37 as described in detail below. The blades are retained in the frame 31 by metal clips 39 wrapped around the ends of the frame in a manner known per se. Protrusions 40 on the outer faces of the cap elements 36, 37 have upper ends that are in alignment with the projections 38 and can provide a skin guiding or control function in use of the razor.

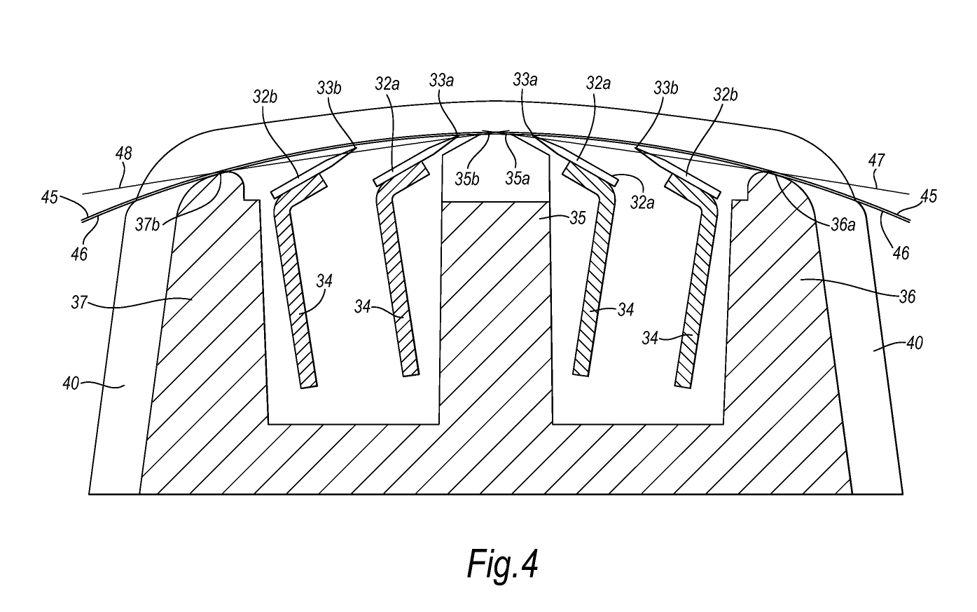

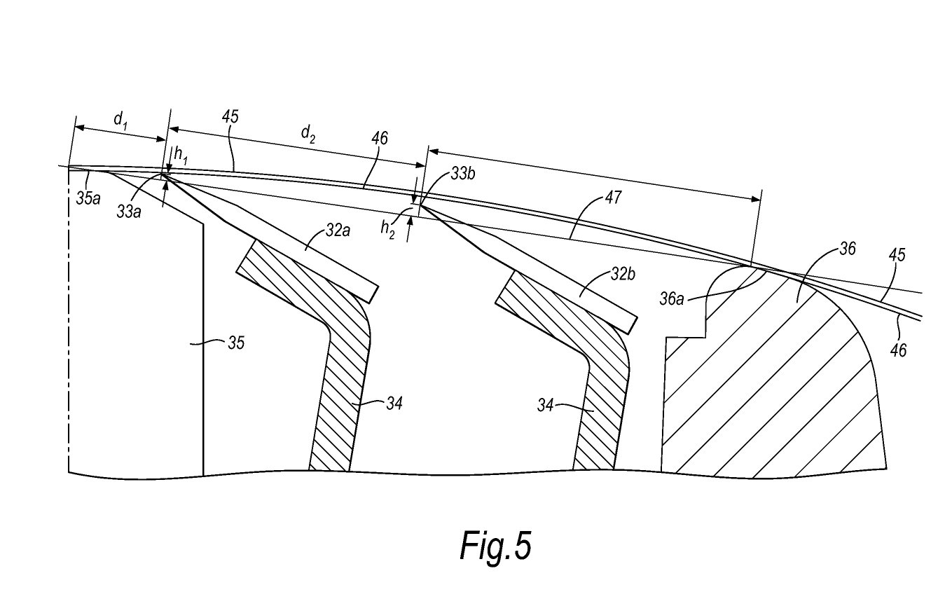

As can be best seen in FIGS. 4 and 5, the pairs of blades 32 are arranged symmetrically on opposite sides of the guard element 35, each pair of blades including a front blade 32a nearest the guard element and a following blade 32b. Included on the drawings are two circular arcs 45, 46 both centred on the axis about which the blade unit 110 are oscillated by the motor 18. The arc 15 of larger radius indicates the location of the edges of the opening 113 in the cartridge casing 112 through which the blade unit contacts the skin, whereas the arc 46 of smaller radius circumscribes the guard and cap elements 35, 36, 37, whereby the radial distance between the two arcs 45, 46 represents a working clearance for the oscillation of the blade unit 110 within the cartridge casing 112. In the illustrated embodiment the arc 45 has a radius of 10.00 mm and the arc 46 has a radius of 9.98 mm. A first plane 47 extends between positions at which the circumscribing arc meets a first surface 35a on the guard element 35 and a surface 36a on the first cap element 36, and a second plane 48 is extends between positions at which the circumscribing arc meets a second surface 35b on the guard element 35 and a surface 37b on the second cap element 37. The first and second planes 47, 48, when extended, intersect at a point above the centre of the guard element at an obtuse angle less than 180° . The first pair of blades is positioned so that the cutting edges of both blades are located above, the first plane 47 and not higher than, and preferably below, the circumscribing arc 46. Due to the symmetrical blade arrangement the second pair of blades is similarly disposed so that the cutting edges of the blades are both not lower than, and preferably above the second plane 48 and not higher than, and preferably below, the circumscribing arc 46. Each following blade 32b has the tip of its cutting edge at a greater height h₂ above the respective adjacent plane 47, 48 than the height h₁ of the tip of the cutting edge of the front blade 32a of the same pair of blades. In the exemplary embodiment shown in the drawings the height h₁ of the tip of the cutting edge of the front blade 32a above the adjacent plane 47, 48 is 0.025 mm and around half the height h₂ of the tip of the cutting edge of the following blade 32b above the plane which is 0.050 mm. Measured along the planes 47, 48, the front blades 32a have the tips of their cutting edges at a distance d₁ of about 0.35 mm from the point of intersection between the first and second planes 47, 48, and the following blades 32b have the tips of their cutting edges at a distance d₂ of about 1.00 mm from the tips of the cutting edges of the front blades 32a. The blade angle at which a plane bisecting the tip of each respective blade intersects the adjacent plane 47, 48 is from 20° to 23° , for example about 21.5° .

The described blade geometry, that is the positions of the cutting edges of the blades 32 between the guard and cap elements 35, 36, 37 can ensure an effective shaving performance in terms of the closeness of shave obtained and a good level of comfort both during and after shaving. The blade unit 110 can be oscillated back and forth through an angle in the range of from about 5° to about 30° which will achieve a blade movement of about 0.3 to 3.0 mm along the skin surface for cutting hairs. A suitable oscillation speed is around 95 Hz, which with the geometry described can produce and average blade speed of about 600 mm/sec. Speeds of this order can sufficient to ensure that the pairs of blades will act with maximum effect in succession to cut individual hairs in both oscillation directions and with the razor head as a whole being moved across the skin surface at a typical shaving speed of about 225 mm/sec. The pair of blades that is not performing a cutting action at any instant in time may be effective in raking up low lying hairs to improve the cutting efficiency of the other active pair of blades.

It should be understood that the foregoing description of the preferred embodiment is given by way of non-limiting example only and that modifications and variations are possible without departing from the scope of the invention as defined by the claims which follow. The invention has been particularly described with reference to a blade unit structure in which the guard and cap elements remain in fixed predetermined positions relative to one another during shaving. If any one or more of the guard and cap elements, or indeed the blades, is moveable within the blade unit the circumscribing arc and the first and second planes should be determined at any of the positions of the moveable element or moveable elements that can arise in the course of shaving as a result of the forces imposed on the skin contacting parts.

List of Reference Numerals

A. Pivot axis

1. Razor handle

2. Yoke

3. Pivot elements

5. Head Structure

6. Body

7. End Members

9. Motor housing

14. Spigot

15. Cover

16. Cable entry

18. Motor

19. Drive Shaft

20. Cam element

31. Frame

32, 32a, 32b. Blades

33a & 33b. Cutting edges

34. Blade supports

35. Guard element

35a & 35b. Guard element surfaces

36. First cap element

36a. First cap element surface

37. Second cap element

37b. Second cap element surface

38. Projections

39. Blade retention clips

40. Protrusions

42. Flexible tube

45. Circular arc

46. Circumscribing arc

47. First plane

48. Second plane

d₁. Distance from intersections of the first and second planes to tip of front blade

d₂. Distance between tips of front and following blades

h₁& h₂. Height of blade tips above the first and second planes

101. Platform

102. Journals

103. Drive arm

104. Slot

105. Slot

108. Sealing boot

109. Directional arrows

110. Blade unit

112. Casing

113. Opening

114. Guard strip

115. Lubricating strip

What is claimed is:

1. A blade unit in or for a razor comprising a guard element (35), first and second cap elements (36, 37) on opposite sides of the guard element, a plurality of blades (32) with cutting edges (33) disposed between the guard element (36) and the first cap element (36) and facing towards the guard element (35), and at least one blade (32) with a cutting edge (33) disposed between the guard element (35) and the second cap element (37) and facing towards the guard element (35), wherein the first cap element (36), the guard element (35) and the second cap element (37) are circumscribed by an arc of a circle (46), a first plane (47) extends between positions at which the circumscribing arc (46) meets a first surface (35a) on the guard element (35) and a surface (36a) on the first cap element (36), a second plane (48) extends between positions at which the circumscribing arc (46) meets a second surface (35b) on the guard element (35) and a surface (37b) the second cap element (37), characterised in that the cutting edge (33) of at least one of the blades (32) in said plurality of blades has a position that is above the first plane (47) and at or below the circumscribing arc (46).

2. A blade unit according to claim 1, wherein the cutting edge (33a, 33b) of each blade (32a, 32b) in the plurality of blades has a position between the first plane (47) and the circumscribing arc (46).

3. A blade unit according to claim 1 or 2, wherein there is a second plurality of blades (32) with cutting edges (33) disposed between the guard element (35) and the second cap element (37), and the cutting edge (33) of at least one of the blades (32) in the second plurality of blades has a position that is above the second plane (48) and at or below the circumscribing arc(46).

4. A blade unit according to claim 3, wherein the cutting edge (33a, 33b) of each blade (32a, 32b) in the second plurality of blades has a position between the second plane (48) and the circumscribing arc (46).

5. A blade unit according to any one of claims 1 to 4, wherein the circumscribing arc (46) has a radius of from 8.0 mm to 12.0 mm.

6. A blade unit according to claim 5, wherein the radius of the circumscribing arc (46) is from 9.0 mm to 11.0 mm, preferably from 9.5 mm to 10.5 mm.

7. A blade unit according any one of the preceding claims, wherein in the or at least one plurality of blades the cutting edge (33b) of a blade (32b) further from the guard element (35) is positioned at a greater distance (h₂) from the adjacent one of the first and second planes (47, 48) than the cutting edge (33a) of a blade closer (32a) to the guard element (35).

8. A blade unit according to any one of the preceding claims, wherein in the or at least one plurality of blades the cutting edge (33b) of a blade (32b) further from the guard element (35) has a position inside the circumscribing arc (46) and at a greater distance from the circumscribing arc than the cutting edge (33a) of a blade (32a) closer to the guard element (35).

9. A blade unit according to any one of the preceding claims, wherein in the or at least one plurality of blades the cutting edge (33a) of the blade closest (32a) the guard element (35) is at a distance (d₁) of from 0.2 mm to 1.2 mm, preferably 0.2 mm to 0.7 mm, from a point at which extensions of the first and second planes (47, 48) intersect, said distance being measured along the adjacent plane.

10. A blade unit according to claim 9, wherein said distance (d₁) of the cutting edge (33a) from the intersection between the first and second planes (47, 48) is from 0.25 mm to 0.45 mm.

11. A blade unit according to any one of the preceding claims, wherein in the or at least one plurality of blades the tips of the cutting edges (33a, 33b) of two adjacent blades (32a, 32b) are separated by a distance (d₂) of 0.2 mm to 1.5 mm, preferably 0.6 mm to 1.2 mm, the distance being measured along the adjacent one of the first and second planes (47, 48).

12. A blade unit according to any one of the preceding claims, wherein in the or at least one plurality of blades the tips of the cutting edges (33a, 33b) of two adjacent blades (32a, 32b) are separated by a distance (d₂) of from 0.9 mm to 1.1 mm.

13. A blade unit according to any one of the preceding claims, wherein the or at least one plurality of blades includes a front blade (32a) nearest the guard element (35) and a following blade (32b), and the tip of the cutting edge (33a) of the front blade (32a) has a position at a distance (h₁) of from 0.01 to 0.04 mm, preferably 0.02 to 0.03 mm above the adjacent one of the first and second planes (47, 48).

14. A blade unit according to any one of the preceding claims, wherein the or at least one plurality of blades includes a front blade (32a) nearest the guard element (35) and a following blade (32b), and the tip of the cutting edge (33b) of the following blade (32b) has a position at a distance (h₂) of from 0.03 to 0.07 mm, preferably from 0.04 to 0.06 mm, from the adjacent one of the first and second planes (47, 48).

15. A blade unit according to any one of the preceding claims, wherein the guard element (35) comprises projections (38) spaced apart along the guard element, the projections extending from a base part to free end faces.

16. A blade unit according to any one of the preceding claims, wherein there are two blades (32a, 32b) in the or each plurality of blades.

17. A blade unit according to any one of the preceding claims, wherein the blades (32) are disposed in symmetrical arrangements on opposite sides of the guard element (35).

18. A razor including a blade unit (110) according to any one of the preceding claims.

19. A razor according to claim 18, wherein the blade unit (110) is mounted for pivotal movement relative to a handle (1) of the razor about an axis (A) located substantially at the centre of curvature of the circumscribing arc (46).

20. A razor according to claim 19, including a drive mechanism (18-20) operable to oscillate the blade unit (110) about the pivot axis (A) through an angle that produces blade movement of from about 0.3 mm to about 3.0 mm.
